(19) United States
(12) Patent Application Publication
(10) Pub. No.: US 2026/0127784 A1
(43) Pub. Date: May 7, 2026

(54) SYSTEMS AND METHODS FOR IMPROVED SKIN TONE RENDERING IN DIGITAL IMAGES

(71) Applicant: FITSKIN INC., Toronto (CA)

(72) Inventors: Sergio RATTNER, Toronto (CA); Justinas VILIMAS, Vilnius (LT)

(21) Appl. No.: 19/115,926

(22) PCT Filed: Oct. 10, 2023
(86) PCT No.: PCT/CA2023/051338

§ 371 Date: Mar. 27, 2025

Related U.S. Application Data
(60) Provisional application No. 63/415,140, filed on Oct. 11, 2022.

(51) Int. Cl. G06T 11/10; G06T 3/40; G06T 7/90

(52) U.S. Cl. CPC G06T 11/10; G06T 3/40; G06T 7/90; G06T 2207/10024; G06T 2207/30088; G06T 2207/30201; G06T 2210/36

(57) ABSTRACT

Embodiments of the present disclosure may include a system for improved skin tone rendering, of a user skin tone of a user, in digital images, the system including a first computing device. Embodiments may also include a computing device camera. Embodiments may also include a user skin tone analysis device. In some embodiments, the first computing device may be configured to receive a set of user skin tone images of the user. In some embodiments, the set of user skin tone images may include at least one unprocessed user skin tone image of the user obtained from the computing device camera. In some embodiments, the first computing device may be configured to obtain a skin tone analysis user skin tone image for the user. In some embodiments, the skin tone analysis user skin tone image may be taken using the user skin tone analysis device.

### TECHNICAL FIELD

The present invention relates to improved skin tone rendering in digital images using skin tone analysis devices that attach to computing devices.

### BACKGROUND

Computing devices (smart phones, tablets, digital cameras, and the like) often can take pictures. It is a known challenge for those pictures to accurately capture and display accurate and realistic skin tones, across various colors and shades of skin and various lighting, and other factors, in the images.

Although many approaches to render more accurate skin tones exist, the challenge remains largely unsolved—largely as a result of the limitations of the computing devices being used to capture the images and the resulting lack of ability to properly process the images.

There is accordingly a need for an improved method and system for improved skin tone rendering in digital images.

### BRIEF SUMMARY

There is a system for improved skin tone rendering, of a user skin tone of a user, in digital images, the system comprising: a first computing device configured to: receive a set of user skin tone images of the user, comprising at least an unprocessed user skin tone image of the user obtained from a computing device camera; obtain a skin tone assembly user skin tone image for the user, the skin tone assembly user skin tone image taken using a user skin tone analysis device; extract a user skin tone color value of the user from each image in the set of user skin tone images and the skin tone assembly user skin tone image of the user; calculate a set of user skin tone rendering adjustment factors from the skin tone color values; apply one or more user skin tone rendering adjustment factors from the set of user skin tone rendering adjustment factors to the unprocessed user skin tone image to obtain an adjusted user skin tone image; and output the adjusted user skin tone image.

The first computing device may further comprise a first computing device camera and a user skin tone analysis device that attaches to a computing device in front of first the computing device camera and wherein the obtaining is via the first computing device camera with the user skin tone analysis device in front of the computing device camera and wherein the skin tone analysis user skin tone image for the user is an image of the user.

The skin tone assembly user skin tone image is at a magnification of not less than 10×.

The system may further comprise a database of skin tone assembly skin tone images from a second computing device camera with a second user skin tone analysis device in front of the second computing device camera and wherein the obtaining is from the database of skin tone assembly skin tone images and the skin tone assembly user skin tone image for the user is not an image of the user and is selected based on comparing the unprocessed user skin tone image of the user to a set of skin tone assembly user skin tone images in the database of skin tone assembly skin tone images.

The user skin tone color value may comprise a L* channel, an a* channel and a b* channel.

The set of user skin tone images may comprise an unprocessed skin tone image and a human processed skin tone image.

The extracting may further comprise, for each image in the set of user skin tone images: identifying a set of image pixels comprising a skin surface of the user; summing, for each pixel in the set of image pixels, the L* channel, the a* channel and the b* channel; and dividing the summing, for L* channel, the a* channel and the b* channel, by a number of pixels in the set of image pixels, to arrive at an average L* channel, an average a* channel and an average b* channel.

The set of skin tone rendering adjustment factors may comprise a first skin tone rendering adjustment factor comprising a first difference between the a* channel between the skin tone assembly skin tone images and the unprocessed skin tone image and a second skin tone rendering adjustment factor comprising a second difference between the b* channel between the skin tone assembly skin tone images and the unprocessed skin tone image.

The set of skin tone rendering adjustment factors may further comprise a third skin tone rendering adjustment factor comprising a third difference between the L* channel between the human processed skin tone image and the unprocessed skin tone image and the applying comprises the first skin tone rendering adjustment factor, the second skin tone rendering adjustment factor, and the third skin tone rendering adjustment factor.

The human processed skin tone image may be created from the unprocessed skin tone image, by a human adjusting the unprocessed skin tone image, using image processing software, to make the user skin tone in the human processed skin tone image look empirically more similar to how the human sees the user skin tone in real life.

The extracting may further comprise: identifying a first set of image pixels comprising a skin surface of the user in the unprocessed skin tone image and a second set of image pixels comprising a skin surface of the user in the skin tone assembly user skin tone image for the user; deducing a first mean L* channel for the first set of image pixels and a second mean L* channel for the second set of image pixels; setting a mapping of L* channel values from the first set of image pixels and the second set of image pixels, based on the deducing; using the mapping to create, for each pixel in the first set of image pixels, a pixel skin tone rendering adjustment factors comprising an a* channel adjustment factor and a b* channel adjustment factor; and employing, for each pixel, the a* channel adjustment factor and a b* channel adjustment factor.

Each user skin tone image in the set of user skin tone images may comprise an extracted skin tone snippet of the user and the applying may be to the extracted skin tone snippet in the unprocessed user skin tone image.

The outputting may comprise one or more of displaying the adjusted user skin tone image on a screen of the computing device or storing the adjusted user skin tone image on a memory of the computing device.

There is also a method for improved skin tone rendering, of a user skin tone of a user, in digital images, the method comprising: receiving, by a computing device, a set of user skin tone images of the user, comprising at least an unprocessed user skin tone image of the user obtained from a computing device camera; obtaining a skin tone assembly user skin tone image for the user, the skin tone assembly user skin tone image taken using a user skin tone analysis device; extracting a user skin tone color value of the user from each image in the set of user skin tone images and the skin tone assembly user skin tone image of the user; calculating a set of user skin tone rendering adjustment factors from the skin tone color values; applying one or more user skin tone rendering adjustment factors from the set of user skin tone rendering adjustment factors to the unprocessed user skin tone image to obtain an adjusted user skin tone image; outputting the adjusted user skin tone image.

The obtaining may be via the computing device, the computing device further comprising a computing device camera and a user skin tone analysis device, with a user skin tone analysis device in front of the computing device camera and wherein the skin tone assembly user skin tone image for the user is an image of the user.

The skin tone assembly user skin tone image may be at a magnification of not less than 10×.

The obtaining may be from a database of skin tone assembly skin tone images and the skin tone assembly user skin tone image for the user is not an image of the user and is selected based on comparing the unprocessed user skin tone image of the user to a set of skin tone assembly user skin tone image in the database of skin tone assembly skin tone images.

The user skin tone color value may comprise a L* channel, an a* channel and a b* channel.

The set of user skin tone images may comprise an unprocessed skin tone image and a human processed skin tone image.

The extracting may further comprise, for each image in the set of user skin tone images: identifying a set of image pixels comprising a skin surface of the user; summing, for each pixel in the set of image pixels, the L* channel, the a* channel and the b* channel; and dividing the summing, for L* channel, the a* channel and the b* channel, by a number of pixels in the set of image pixels, to arrive at an average L* channel, an average a* channel and an average b* channel.

The set of skin tone rendering adjustment factors may comprise a first skin tone rendering adjustment factor comprising a first difference between the a* channel between the skin tone assembly skin tone images and the unprocessed skin tone image and a second skin tone rendering adjustment factor comprising a second difference between the b* channel between the skin tone assembly skin tone images and the unprocessed skin tone image.

The set of skin tone rendering adjustment factors may further comprise a third skin tone rendering adjustment factor comprising a third difference between the L* channel between the human processed skin tone image and the unprocessed skin tone image and the applying comprises the first skin tone rendering adjustment factor, the second skin tone rendering adjustment factor, and the third skin tone rendering adjustment factor.

The method may further comprise creating the human processed skin tone image by a human adjusting the unprocessed skin tone image, using image processing software, to make the user skin tone in the human processed skin tone image look empirically more similar to how the human sees the user skin tone in real life.

The extracting may further comprise: identifying a first set of image pixels comprising a skin surface of the user in the unprocessed skin tone image and a second set of image pixels comprising a skin surface of the user in the skin tone assembly user skin tone image for the user; deducing a first mean L* channel for the first set of image pixels and a second mean L* channel for the second set of image pixels; setting a mapping of L* channel values from the first set of image pixels and the second set of image pixels, based on the deducing; using the mapping to create, for each pixel in the first set of image pixels, a pixel skin tone rendering adjustment factors comprising an a* channel adjustment factor and a b* channel adjustment factor; and employing, for each pixel, the a* channel adjustment factor and a b* channel adjustment factor.

Each user skin tone image in the set of user skin tone images may comprise an extracted skin tone snippet of the user and the applying is to the extracted skin tone snippet in the unprocessed user skin tone image.

The outputting may comprise one or more of displaying the adjusted user skin tone image on a screen of the computing device or storing the adjusted user skin tone image on a memory of the computing device.

### BRIEF DESCRIPTION OF THE FIGURES

FIG. 1 is a block diagram illustrating a system, according to some embodiments of the present disclosure.

FIG. 2 is a block diagram further illustrating the system from FIG. 1, according to some embodiments of the present disclosure.

FIG. 3 is a flowchart illustrating a method, according to some embodiments of the present disclosure.

FIG. 4 is a flowchart further illustrating the method from FIG. 3, according to some embodiments of the present disclosure.

FIG. 5 is a flowchart further illustrating the method from FIG. 3, according to some embodiments of the present disclosure.

FIG. 6 is an example of user skin tone images through various stages of the methods described herein, according to some embodiments of the present disclosure.

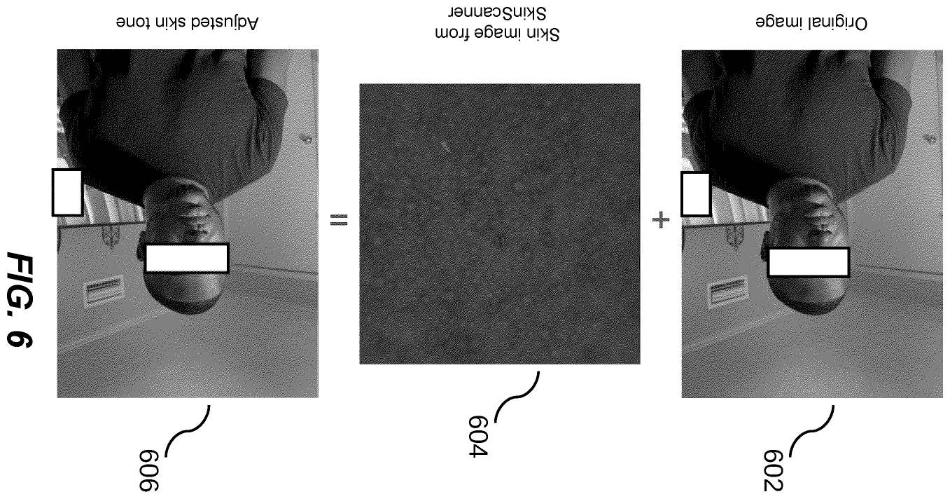

FIG. 7 is an example of identifying skin tone image snippets, according to some embodiments of the present disclosure.

### DETAILED DESCRIPTION

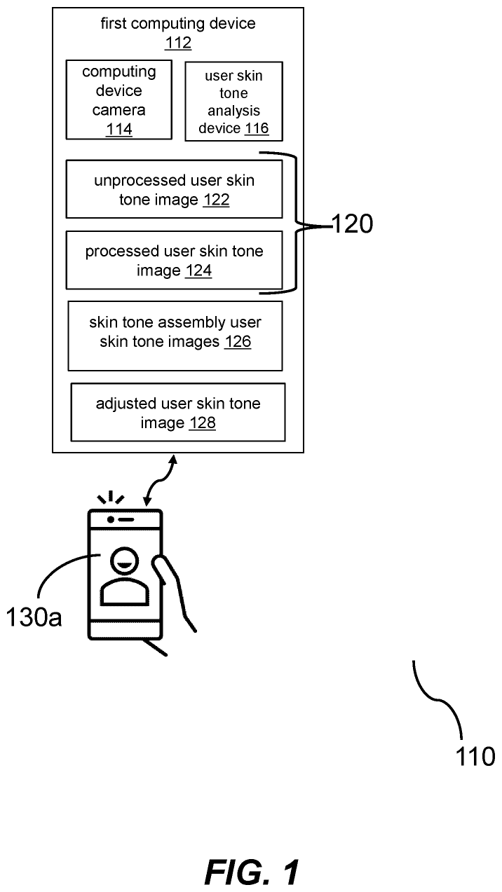

FIG. 1 is a block diagram that describes a system 110, according to some embodiments of the present disclosure. In some embodiments, the system 110 may include a first computing device 112, a computing device camera 114, a user skin tone analysis device 116 and one or more of images of a user 130a stored in volatile or non-volatile memory (not shown) on computing device 112, such as unprocessed user skin tone image(s) 122, processed user skin tone image(s) 124, skin tone analysis user skin tone images 126, and adjusted user skin tone image(s) 128.

Broadly, system 110, as shown in FIG. 1, shows an embodiment where a user 130a may take a picture that includes themselves (an unprocessed user skin tone image 122—an example of which can be seen at 602), and can also take a skin tone assembly user skin tone image 126 (taken with the skin tone assembly and which may be at a magnification of 10×+ and using cross-polarized light and under controlled lighting conditions—computing device 112 and computing device 114 along with user skin tone analysis device 116—an example of which can be seen at 604), and then process the unprocessed skin tone image 122 (for example using the photo app on their computing device) to make the picture of them look more accurate and create processed skin tone image 124 (or “human processed user skin tone image 124), to allow functionality described herein to be performed and arrive at an adjusted user skin tone image 128 (—an example of which can be seen at 606). The embodiment of system 110 may use only images of the user 130a.

The first computing device 112 may be configured to receive a set of user skin tone images 120 of the user, either from computing device camera 114 and storage on computing device 112 (for example after human processing via an app on computing device 112) or from an external source. The set of user skin tone images 120 may include at least one unprocessed user skin tone image 122 of the user obtained from the computing device camera 114 or an external camera.

The first computing device 112 may be configured to obtain a skin tone analysis user skin tone image for the user. The skin tone analysis user skin tone image may be taken using the user skin tone analysis device 116.

User skin tone analysis device (USTAD) 116/216 may be the hardware as described in PCT/CA2020/050216 or PCT/CA2017/050503 or may comprise another skin tone analysis system that is capable of taking images of a user's skin, the images having characteristics that are sufficient for the analysis described herein. USTAD may have an SDK running on it that allows an application on computing devices to enable, control, or review methods described herein. Notably, and as mentioned, system 110 requires the ability to obtain user skin tone images that allow the processing described herein. In one embodiment, user skin tone images, and in particular skin tone analysis device user skin tone images 126 may be taken using cross polarized light (for example to remove glare, or reflection of the light source from the skin image), for example with a 10 megapixel camera at a magnification of not less than 10× and up to 30×. Magnification and cross-polarized light in images, that may be used for comparison and analysis purposes, may help overcome some of the hardware limitations of computing devices that make accurate skin tone assessment and rendering difficult.

User skin images may be in one of several color formats, such as LAB (having L* channel, a* channel and b* channel for each pixel) or RGB. User skin images can be substantially of any quality, type, format or size/file size, provided the methods herein can be applied. For example, images may be compressed or not compressed, raw or processed, and in a variety of file formats.

In some embodiments, the first computing device 112 may be configured to extract a user skin tone color value of the user from each image in the set of user skin tone images 120 and the skin tone analysis user skin tone image of the user. The first computing device 112 may be configured to calculate a set of user skin tone rendering adjustment factors from the skin tone color values. The first computing device 112 may be configured to apply one or more user skin tone rendering adjustment factors from the set of user skin tone rendering adjustment factors to the unprocessed user skin tone image 122 to obtain an adjusted user skin tone image.

In some embodiments, the user skin tone analysis device 116/216 may be attached to a computing device (such as 112 or 212) in front of the computing device camera 114. The obtaining may be via the computing device camera 114 with the user skin tone analysis device 116 in front of the computing device camera 114. The skin tone analysis user skin tone image for the user may be an image of the user.

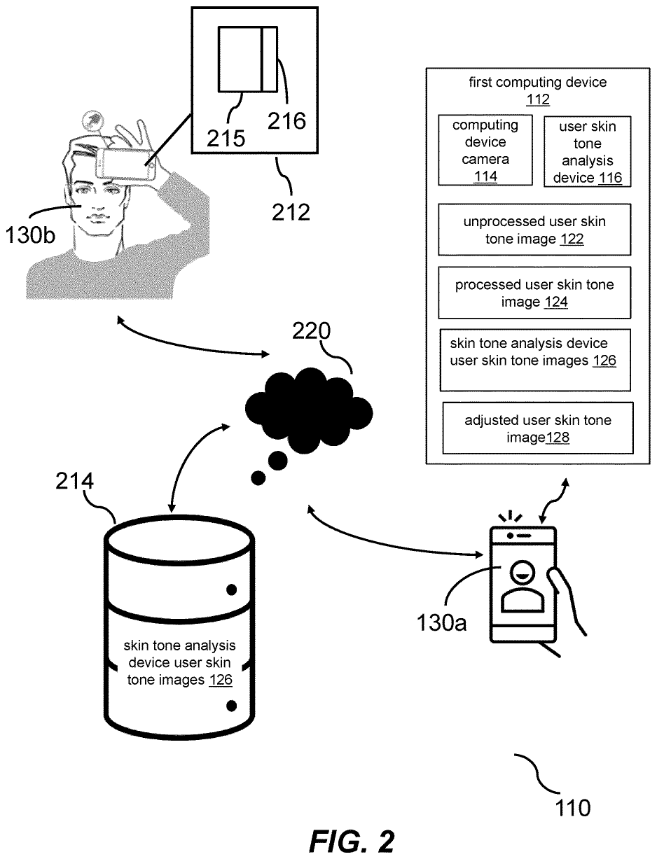

FIG. 2 is a block diagram that further describes the system 110 from FIG. 1, according to some embodiments of the present disclosure.

Broadly, system 110, as shown in FIG. 2, shows an embodiment where a user 130a may take a picture that includes themselves (an unprocessed user skin tone image 122), and can also use a skin tone assembly user skin tone image 126 that may or may not include themselves in the image (taken with the skin tone assembly—computing device 212 and computing device or database 214 along with user skin tone analysis device 216, where their computing device 112 may not need or have USTAD 116), and then process the unprocessed skin tone image 122 (for example using the photo app on their computing device) to make the picture of them look more accurate (producing a processed user skin tone image, or “human processed user skin tone image”), or possibly to continue without doing any human processing and use the functionality described herein that does not require such human intervention, to allow functionality described herein to be performed. The embodiment of system 110 may use images of the user 130a, along with images for the user (but not “of the user”) to provide the functionality described herein.

In some embodiments, the system 110 may include a database 214 of skin tone analysis skin tone images, a second computing device camera 215, and a second user skin tone analysis device 216 in front of the second computing device camera 215 and a network 220 (such as the Internet, one or more local or wide area networks, and which may have wired and wireless components and may comprise various hardware and software components, as known in the art). The database 214 of skin tone analysis skin tone images may be obtained via or from the second computing device camera 215 and may be of many different users (130b and others). The obtaining may be from the database 214 of skin tone analysis skin tone images and the skin tone analysis user skin tone image for the user may be not an image of the user and may be selected based on comparing the unprocessed user skin tone image 122 of the user to the database 214 of skin tone analysis skin tone images.

Database 214 may be a server that stores and processes skin tone images, such as skin tone assembly user skin tone images 126 (from one or more users 130a, 130b and others), as described herein. Database 214 may be any combination of web servers, applications servers, and database servers, as would be known to those of skill in the art. Each of such servers may comprise typical server components including processors, volatile and non-volatile memory storage devices and software instructions executable thereon. Database 214 may communicate via app to perform the functionality described herein, including exchanging skin images, product recommendations, e-commerce capabilities, and the like. Of course the app may perform these, alone or in combination with database 214, as well.

Database 214 may include a database server that receives and stores all skin tone images from all users into a user profile for each registered user and guest user. These may be received from one or more USTAD 116/216, though the app may be configurable to store skin images locally only (though that may preclude some of the results information based on population and demographic comparisons). Database 214 (for example via a database server, not shown) may provide various analysis functionality as described herein and may provide various display functionality as described herein.

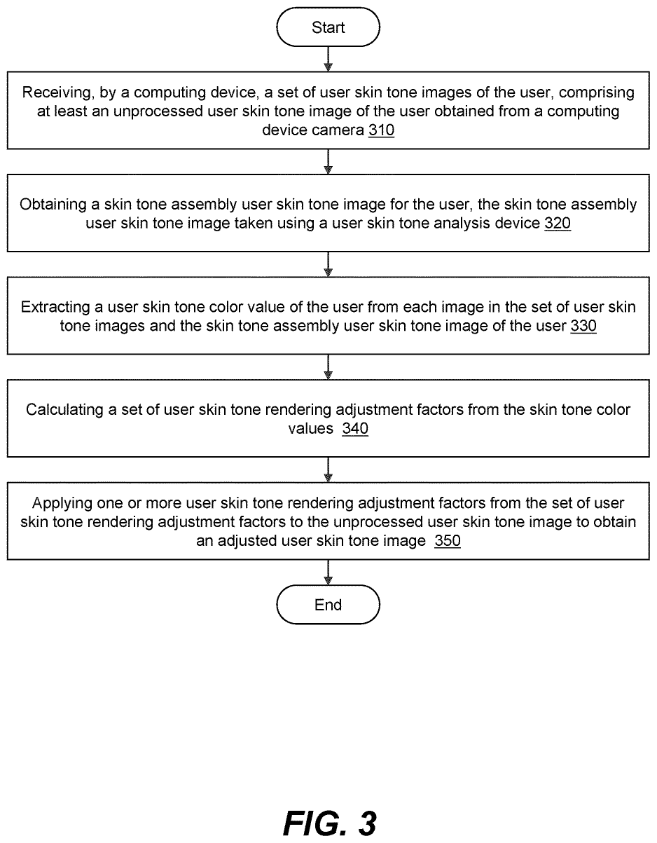

FIG. 3 is a flowchart that describes a method, according to some embodiments of the present disclosure. In some embodiments, at 310, the method may include receiving, by a computing device, a set of user skin tone images of the user, comprising at least an unprocessed user skin tone image of the user obtained from a computing device camera. At 320, the method may include obtaining a skin tone analysis user skin tone image for the user, the skin tone analysis user skin tone image taken using a user skin tone analysis device.

In some embodiments, at 330, the method may include extracting a user skin tone color value of the user from each image in the set of user skin tone images and the skin tone analysis user skin tone image of the user. At 340, the method may include calculating a set of user skin tone rendering adjustment factors from the skin tone color values. At 350, the method may include applying one or more user skin tone rendering adjustment factors from the set of user skin tone rendering adjustment factors to the unprocessed user skin tone image to obtain an adjusted user skin tone image.

In some embodiments, the obtaining may be via a computing device camera with a user skin tone analysis device in front of the computing device camera. The skin tone analysis user skin tone image for the user may be an image of the user. In some embodiments, the skin tone analysis user skin tone image may be at a magnification of not less than 10×. In some embodiments, the applying may be to the extracted skin tone snippet in the unprocessed user skin tone image.

In some embodiments, the obtaining may be from a database of skin tone analysis skin tone images and the skin tone analysis user skin tone image for the user may be not an image of the user and may be selected based on comparing the unprocessed user skin tone image of the user to the database of skin tone analysis skin tone images.

In some embodiments, the user skin tone color value may comprise a L*channel, an a*channel and a b*channel. In some embodiments, the set of user skin tone images may comprise an unprocessed skin tone image and a human processed skin tone image. In some embodiments, the method may include creating the human processed skin tone image by a human adjusting or processing the unprocessed skin tone image, using image processing software, to make the user skin tone in the human processed skin tone image look empirically more similar to how the human sees the user skin tone in real life. This may involve a human adjusting various aspects of the unprocessed skin tone image, including adjusting the L* channel (such as by adjusting the “light” in a camera app).

In some embodiments, each user skin tone image in the set of user skin tone images may comprise an extracted skin tone snippet of the user. In some embodiments, the method may include outputting a result of the color processing. Outputting may include one or more of displaying the adjusted user skin tone image on a screen of the computing device or storing the adjusted user skin tone image on a memory of the computing device. Of course this may also eventually include sending various images and data to database 214.

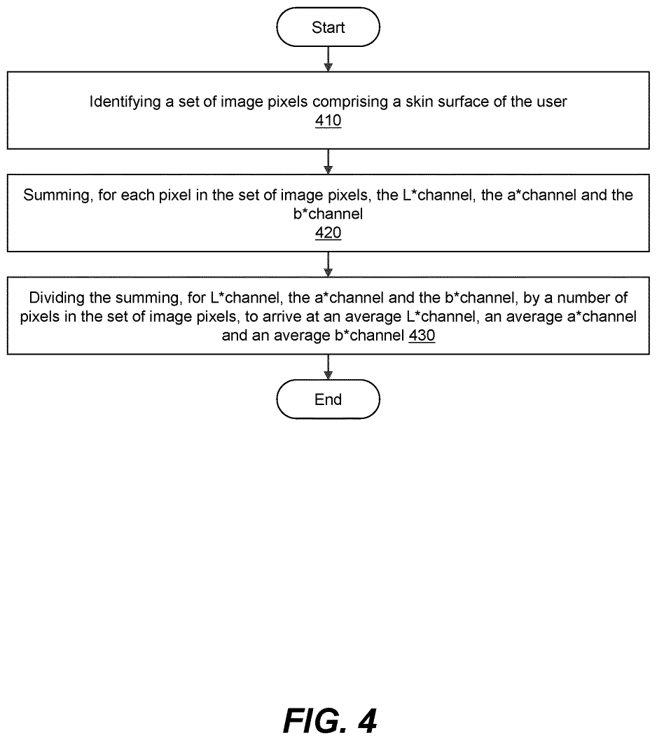

FIG. 4 is a flowchart that further describes the method from FIG. 3, and in particular the extracting, according to some embodiments of the present disclosure. In some embodiments, the extracting a skin tone color value may include, for each image in the set of user skin tone images, 410 to 430. At 410, the extracting a skin tone color value may include identifying a set of image pixels comprising a skin surface of the user. At 420, the extracting may include summing, for each pixel in the set of image pixels, the L*channel, the a*channel and the b*channel. At 430, the extracting may include dividing the summing, for L*channel, the a*channel and the b*channel, by a number of pixels in the set of image pixels, to arrive at an average L*channel, an average a*channel and an average b*channel.

In some embodiments, the set of skin tone rendering adjustment factors may comprise a first skin tone rendering adjustment factor comprising a first difference between the a*channel between the skin tone assembly/analysis skin tone images and the unprocessed skin tone image and a second skin tone rendering adjustment factor comprising a second difference between the b*channel between the skin tone assembly/analysis skin tone images and the unprocessed skin tone image.

In some embodiments, the set of skin tone rendering adjustment factors may further comprise a third skin tone rendering adjustment factor comprising a third difference between the L*channel between the human processed skin tone image and the unprocessed skin tone image and the applying comprises the first skin tone rendering adjustment factor, the second skin tone rendering adjustment factor, and the third skin tone rendering adjustment factor.

By way of example, for the method in FIGS. 3-4, in one embodiment there may be an unprocessed user skin tone image 122, a processed user skin tone image 124 and a skin tone analysis device user skin tone images 126. From each of those images the methods identify the face or skin of the user (assuming just one face is present, noting embodiments of the invention can handle multiple users in each picture, treating each as a separate user to render more accurately, while attempting to maintain any adjustment factors such that each user appears to match each other and the rest of the subject of the adjusted image and the pixels that make up the skin or face. For each of those pixels in a given image the LAB value channel value is added. Then the total for a particular channel is divided by the number of pixels to get the average channel value for the skin pixels in the particular image. That becomes the channel value for that image. After the extraction then the methods have an average LAB value, in each channel, for the skin pixels, in each of the three images. An exemplary set of user skin tone rendering adjustment factors might then be:

$$1 ) a * ChannelAvg ( from image 126 ) - a * ChannelAvg ( from image 122 ) = Delta ( a \text{*)} , which could be for exmple , 122 - 118 = 4.$$

$$2 ) b * ChannelAvg ( from image 126 ) - b * ChannelAvg ( from image 122 ) = Delta ( b \text{*)} , which could be for exmple , 1 \; 15 - 111 = 4. At that point the two user skin tone rendering adjustment factors would be Delta ( a \text{*)} = 4 and a Delta ( b \text{*)} = 4.$$

$$3 ) L * ChannelAvg ( from image 124 ) - L * ChannelAvg ( from image 122 ) = Delta ( L \text{*)} , which could be for exmple , 87 - 73 = 14. This would provide a Delta ( L \text{*)} = 14.$$

Now having Delta(a*)=4 and a Delta(b*)=4 and Delta(L*)=14, each pixel in the unprocessed portrait photo is considered and each of the Delta(L*), Delta(a*) and Delta(b*) values is applied to each pixel. So if the unprocessed pixel's LAB value was (73, 122, 122) then applying would be (73, 122, 122)−Delta(L*=14), Delta(a*)=4 and Delta(b*)=4, so that the new LAB value for the pixel in the (now adjusted) image 128 would be (87, 126, 126).

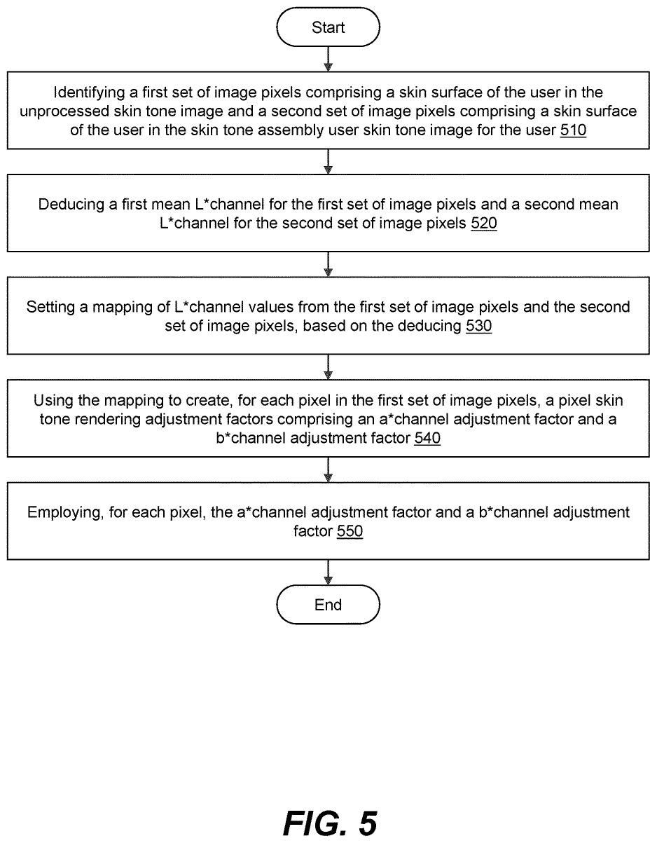

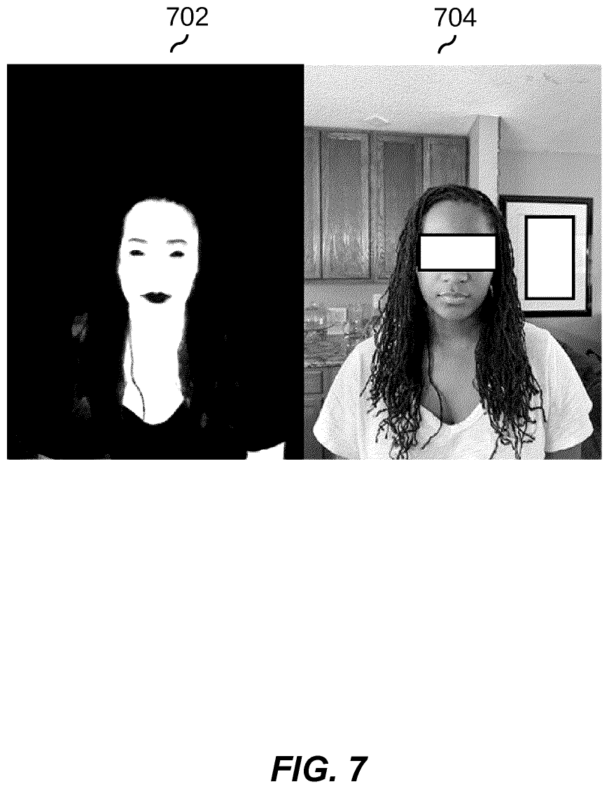

FIG. 5 is a flowchart that further describes the method from FIG. 3, and in particular the calculating, according to some embodiments of the present disclosure. In some embodiments, the extracting may include 510 to 550. At 510, the extracting may include identifying a first set of image pixels comprising a skin surface of the user in the unprocessed skin tone image (for example as shown in FIG. 7 where 704 is an unprocessed user skin tone image 122 and 702 is the set of image pixels—in white—comprising user 130a's skin) and a second set of image pixels comprising a skin surface of the user in the skin tone analysis user skin tone image for the user (which may be substantially each pixel, for example based on USTAD 116). At 520, the extracting may include deducing a first mean L*channel for the first set of image pixels and a second mean L*channel for the second set of image pixels. At 530, the extracting may include setting a mapping of L*channel values from the first set of image pixels and the second set of image pixels, based on the deducing (for example using a delta from mean, weighting of the mean, and the like). At 540, the extracting may include using the mapping to create, for each pixel in the first set of image pixels, a pixel skin tone rendering adjustment factors comprising an a*channel adjustment factor and a b*channel adjustment factor. At 550, the extracting may include employing, for each pixel, the a*channel adjustment factor and a b*channel adjustment factor.

By way of example, for the method in FIG. 5, all of the pixels from that skin area may be used from an unprocessed user skin tone image. Those may be put in an array and the duplicates removed (where all LAB channels match) and then sort by L* for example. This may result in a bell curve if plotted as a histogram for L* (pixel count on the vertical axis). The same may be done for user skin analysis user skin tone image (which may show skin texture more clearly via the increased detail), resulting in two pixel arrays—one from the portrait photo (unprocessed user skin tone image) and one from skin texture. This may result in similar looking histograms, only the L* mean may be at a different spot. From there a formula would be determined to map the pixels from portrait photo pixel array to the skin texture array. As described, this may be just a delta of L* mean from both arrays or could be one or more different approaches. The result, however, is a formula where you could say for every pixel: L* of 48.5 from the portrait photo (image 122) pixel array maps to L* of 54.5 from skin texture pixel array (image 126), which then you can use to calculate the delta a*'s and b*'s for every pixel in an image. This may provide more skin texture detail and a more accurate representation of details like pores, moles, lines, etc in adjusted user skin tone image 128 and may also better show highlights and shadows.

It may be desirable to omit the need for one or both of (I) a skin tone assembly user skin tone images 126 of the user 130a themselves (relying on database 214 and the skin tone assembly user skin tone images 126 therein—choosing the best match for user 130a to render the methods herein accurate) and (II) for a human processed image 124.
1) Omit skin tone assembly user skin tone images 126 of the user 130a themselves. This may be accomplished, for example, by training an ML model that can produce a LAB value (from an unprocessed image 122) of a skin color matching to a result that would be obtained by scanning the user's skin with a scanner (i.e. getting an actual image 126 of the user, using user skin tone analysis device 116). With that, the closest match in database 214 would be used to calculate a set of user skin tone rendering adjustment factors, such as one of the sets described herein. Notably, information from the computing device camera (beyond the unprocessed user skin tone image 122) may be used, such as information about magnification and lighting, might be used to arrive at the best match from the database 214.
2) Omit a human processed image 124. This may also be accomplished, for example, using ML to train a model that would output a Delta(L*) based on the unprocessed image 122. Similarly, information from the computing device camera (used to take unprocessed image 122) would be used (such as estimated ambient light parameters, average LAB of the background and foreground pixels, skin texture and location, and the like). For example, the method could use the computing device's processing engine (such as via their SDK and APIs), by taking many photos in different lighting conditions and measuring the Delta(L*) between unprocessed user skin tone images 122 and processed user skin tone images 124.

In practice, embodiments of the present invention, to correct skin tone rendering in unprocessed user skin tone images, may be implemented either before an AI/ML solution is trained, and/or after. Prior to training, at least one unprocessed user skin tone image can be paired with at least one skin tone assembly user skin tone image for the user (“for” the user meaning either “of” the user or chosen for the user, for example from database 214, and optionally with at least one human processed skin tone image (generally “of” the user). At that point the system would have a skin tone assembly user skin tone image for the user and would know what that skin looks like under a known light source (for example D65, as may be used in the skin tone analysis device). The various skin tone rendering adjustment factors may be determined, as described herein, and applied, as described herein—for example to adjust for the lighting present in the unprocessed user skin tone image. Of course, and as noted herein, it may be preferable to be able to determine and apply appropriate skin tone rendering adjustment factors to an unprocessed user skin tone image without relying on a human to create a human processed skin tone image or having a skin analysis device present with the user/human when they are wanting to have a more accurate skin tone rendering of a given unprocessed user skin tone image. In such cases database 214 and a trained AI/ML model may be used to obviate such needs, while providing the required skin tone rendering adjustment factors to arrive at an adjusted user skin tone image, as described herein.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program”, “app” or “application” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

This written description uses examples to disclose the invention and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. A system for improved skin tone rendering, of a user skin tone of a user, in digital images, the system comprising:
a first computing device configured to:
receive a set of user skin tone images of the user, comprising at least an unprocessed user skin tone image of the user obtained from a computing device camera;
obtain a skin tone assembly user skin tone image for the user, the skin tone assembly user skin tone image taken using a user skin tone analysis device;
extract a user skin tone color value of the user from each image in the set of user skin tone images and the skin tone assembly user skin tone image of the user;
calculate a set of user skin tone rendering adjustment factors from the skin tone color values;
apply one or more user skin tone rendering adjustment factors from the set of user skin tone rendering adjustment factors to the unprocessed user skin tone image to obtain an adjusted user skin tone image; and
output the adjusted user skin tone image.

2. The system of claim 1 wherein the first computing device further comprises a first computing device camera and a user skin tone analysis device that attaches to the first computing device in front of first computing device camera and wherein the obtaining is via the first computing device camera with the user skin tone analysis device in front of the computing device camera and wherein the skin tone assembly user skin tone image for the user is an image of the user.

3. The system of claim 2 wherein the skin tone assembly user skin tone image is at a magnification of not less than 10×.

4. The system of claim 1 further comprising a database of skin tone assembly skin tone images from a second computing device camera with a second user skin tone analysis device in front of the second computing device camera and wherein the obtaining is from the database of skin tone assembly skin tone images and the skin tone assembly user skin tone image for the user is not an image of the user and is selected based on comparing the unprocessed user skin tone image of the user to a set of skin tone assembly user skin tone images in the database of skin tone assembly skin tone images.

5. The system of claim 1 wherein the user skin tone color value comprises a L* channel, an a* channel and a b* channel.

6. The system of claim 5 wherein the set of user skin tone images comprises an unprocessed skin tone image and a human processed skin tone image.

7. The system of claim 6 wherein the extracting further comprises, for each image in the set of user skin tone images:
identifying a set of image pixels comprising a skin surface of the user;
summing, for each pixel in the set of image pixels, the L* channel, the a* channel and the b* channel; and
dividing the summing, for L* channel, the a* channel and the b* channel, by a number of pixels in the set of image pixels, to arrive at an average L* channel, an average a* channel and an average b* channel.

8. The system of claim 7 wherein the set of skin tone rendering adjustment factors comprises a first skin tone rendering adjustment factor comprising a first difference between the a* channel between the skin tone assembly skin tone images and the unprocessed skin tone image and a second skin tone rendering adjustment factor comprising a second difference between the b* channel between the skin tone assembly skin tone images and the unprocessed skin tone image.

9. The system of claim 8 wherein the set of skin tone rendering adjustment factors further comprises a third skin tone rendering adjustment factor comprising a third difference between the L* channel between the human processed skin tone image and the unprocessed skin tone image and the applying comprises the first skin tone rendering adjustment factor, the second skin tone rendering adjustment factor, and the third skin tone rendering adjustment factor.

10. The system of claim 6 wherein the human processed skin tone image is created from the unprocessed skin tone image, by a human adjusting the unprocessed skin tone image, using image processing software, to make the user skin tone in the human processed skin tone image look empirically more similar to how the human sees the user skin tone in real life.

11. The system of claim 5 wherein the extracting further comprises:
identifying a first set of image pixels comprising a skin surface of the user in the unprocessed skin tone image and a second set of image pixels comprising a skin surface of the user in the skin tone assembly user skin tone image for the user;
deducing a first mean L* channel for the first set of image pixels and a second mean L* channel for the second set of image pixels;
setting a mapping of L* channel values from the first set of image pixels and the second set of image pixels, based on the deducing;
using the mapping to create, for each pixel in the first set of image pixels, a pixel skin tone rendering adjustment factors comprising an a* channel adjustment factor and a b* channel adjustment factor;
employing, for each pixel, the a* channel adjustment factor and a b* channel adjustment factor.

12. The system of claim 1 wherein each user skin tone image in the set of user skin tone images comprises an extracted skin tone snippet of the user.

13. The system of claim 12 wherein the applying is to the extracted skin tone snippet in the unprocessed user skin tone image.

14. The system of claim 1, wherein outputting comprises one or more of displaying the adjusted user skin tone image on a screen of the computing device or storing the adjusted user skin tone image on a memory of the computing device.

15. A method for improved skin tone rendering, of a user skin tone of a user, in digital images, the method comprising:
receiving, by a computing device, a set of user skin tone images of the user, comprising at least an unprocessed user skin tone image of the user obtained from a computing device camera;
obtaining a skin tone assembly user skin tone image for the user, the skin tone assembly user skin tone image taken using a user skin tone analysis device;
extracting a user skin tone color value of the user from each image in the set of user skin tone images and the skin tone assembly user skin tone image of the user;
calculating a set of user skin tone rendering adjustment factors from the skin tone color values;
applying one or more user skin tone rendering adjustment factors from the set of user skin tone rendering adjustment factors to the unprocessed user skin tone image to obtain an adjusted user skin tone image; and
outputting the adjusted user skin tone image.

16. The method of claim 15 wherein the obtaining is via the computing device, the computing device further comprising a computing device camera and a user skin tone analysis device, with the user skin tone analysis device in front of the computing device camera and wherein the skin tone assembly user skin tone image for the user is an image of the user.

17. The method of claim 16 wherein the skin tone assembly user skin tone image is at a magnification of not less than 10×.

18. The method of claim 15 wherein the obtaining is from a database of skin tone assembly skin tone images and the skin tone assembly user skin tone image for the user is not an image of the user and is selected based on comparing the unprocessed user skin tone image of the user to a set of skin tone assembly user skin tone image in the database of skin tone assembly skin tone images.

19. The method of claim 15 wherein the user skin tone color value comprises a L* channel, an a* channel and a b* channel.

20. The method of claim 19 wherein the set of user skin tone images comprises an unprocessed skin tone image and a human processed skin tone image.

21. The method of claim 20 wherein the extracting further comprises, for each image in the set of user skin tone images:
identifying a set of image pixels comprising a skin surface of the user;
summing, for each pixel in the set of image pixels, the L* channel, the a* channel and the b* channel; and
dividing the summing, for L* channel, the a* channel and the b* channel, by a number of pixels in the set of image pixels, to arrive at an average L* channel, an average a* channel and an average b* channel.

22. The method of claim 21 wherein the set of skin tone rendering adjustment factors comprises a first skin tone rendering adjustment factor comprising a first difference between the a* channel between the skin tone assembly skin tone images and the unprocessed skin tone image and a second skin tone rendering adjustment factor comprising a second difference between the b* channel between the skin tone assembly skin tone images and the unprocessed skin tone image.

23. The method of claim 22 wherein the set of skin tone rendering adjustment factors further comprises a third skin tone rendering adjustment factor comprising a third difference between the L* channel between the human processed skin tone image and the unprocessed skin tone image and the applying comprises the first skin tone rendering adjustment factor, the second skin tone rendering adjustment factor, and the third skin tone rendering adjustment factor.

24. The method of claim 20 further comprising creating the human processed skin tone image by a human adjusting the unprocessed skin tone image, using image processing software, to make the user skin tone in the human processed skin tone image look empirically more similar to how the human sees the user skin tone in real life.

25. The method of claim 19 wherein the extracting further comprises:
identifying a first set of image pixels comprising a skin surface of the user in the unprocessed skin tone image and a second set of image pixels comprising a skin surface of the user in the skin tone assembly user skin tone image for the user;
deducing a first mean L* channel for the first set of image pixels and a second mean L* channel for the second set of image pixels;
setting a mapping of L* channel values from the first set of image pixels and the second set of image pixels, based on the deducing;
using the mapping to create, for each pixel in the first set of image pixels, a pixel skin tone rendering adjustment factors comprising an a* channel adjustment factor and a b* channel adjustment factor;
employing, for each pixel, the a* channel adjustment factor and a b* channel adjustment factor.

26. The method of claim 15 wherein each user skin tone image in the set of user skin tone images comprises an extracted skin tone snippet of the user.

27. The method of claim 16 wherein the applying is to the extracted skin tone snippet in the unprocessed user skin tone image.

28. The method of claim 15, wherein the outputting comprises one or more of displaying the adjusted user skin tone image on a screen of the computing device or storing the adjusted user skin tone image on a memory of the computing device.
